(19) United States
(12) Patent Application Publication
(10) Pub. No.: US 2009/0153629 A1
(43) Pub. Date: Jun. 18, 2009

(54) LIQUID SUPPLYING DEVICE AND LIQUID EJECTING APPARATUS

(75) Inventor: Hideya Yokouchi, Okaya-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/337,277

(22) Filed: Dec. 17, 2008

(30) Foreign Application Priority Data
Dec. 18, 2007 (JP) 2007-326239
Aug. 29, 2008 (JP) 2008-222050

(51) Int. Cl. B41J 2/175

(52) U.S. Cl. 347/85

(57) ABSTRACT

A liquid supplying device includes a liquid supplying flow path for supplying liquid from an upstream side toward a downstream side on which the liquid is consumed. A pump is driven for a pumping operation in accordance with displacement of a displacement member constituting a part of an inner wall of a pump chamber as a part of the liquid supplying flow path for changing the volume of the pump chamber. A detecting unit detects the remaining amount of the liquid of the liquid supplying source. The liquid supplying source is configured such that the volume of a liquid housing part as a closed space housing the liquid changes in accordance with the remaining amount of the liquid, and the detecting unit detects a liquid-end state in which the none of the liquid inside the liquid housing part remains based on the amount of displacement of the displacement member.

The entire disclosure of Japanese Patent Application No. 2007-326239, filed Dec. 18, 2007 and Japanese Patent Application No. 2008-222050, filed Aug. 29, 2008, are expressly incorporated herein by reference.

### BACKGROUND

1. Technical Field

The present invention relates to a liquid supplying device and a liquid ejecting apparatus that supply a liquid from the upstream side as the liquid supplying source side toward the downstream side on which the liquid is consumed.

2. Related Art

Generally, as one type of liquid ejecting apparatuses, an ink jet recording apparatus (hereinafter, referred to as a printer) has been widely known. The printer performs a printing operation by ejecting ink supplied from a liquid supplying source such as an ink pack housed inside an ink cartridge (hereinafter, referred to as a cartridge) from a liquid ejecting head to a target.

Generally, the printer includes an ink remaining amount detecting unit that is used for detecting the remaining amount of ink inside the ink pack. As the ink remaining amount detecting unit, for example, a unit that calculates the amount of ink consumption by counting the number of times of ink ejection (the number of dots) from the liquid ejecting head and detects the remaining amount of ink by subtracting the calculated amount of ink consumption from the amount of full filled ink (the initial value) has been proposed (see JP-A-5-88552).

As described in JP-A-5-88552, in a general printer, the remaining amount of ink inside the ink pack is detected by performing calculation on the basis of the number of times of ejection of ink. However, the detected remaining amount of ink acquired by the calculation is only an estimated value and does not represent an accurate remaining amount of ink all the time. In other words, erroneous detection indicating that the remaining amount of ink is sufficient for a print operation even in a case where the remaining amount of ink is zero (that is, in the ink end state) or is close to zero (that is, in the ink near-end state) may be acquired.

Thus, generally, in the printer in which the remaining amount of ink is detected by the above-described calculation, the ink end (or near-end) state is assumed for a case where the value of the remaining amount of ink that is detected by the calculation is below a predetermined threshold value that is quite larger than zero, and the need for replacement of a cartridge housing an ink pack that has a remaining amount of ink actually usable is notified by displaying a message or the like. Accordingly, in such a case, there is a problem that ink remaining inside the ink pack of the replaced cartridge is wasted without being used.

### SUMMARY

An advantage of some aspects of the invention is that it provides a liquid supplying device capable of supplying a liquid stored inside a liquid supplying source to the end without any waste in a case where the liquid is supplied from the upstream side as the liquid supplying source side to the downstream side. In addition, another advantage of some aspects of the invention is that it provides a liquid ejecting apparatus including the above-described liquid supplying device.

According to a first aspect of the invention, there is provided a liquid supplying device including: a liquid supplying flow path through which a liquid is supplied from an upstream side as a liquid supplying source side toward a downstream side on which the liquid is consumed; a pump that is driven for a pumping operation in accordance with displacement of a displacement member constituting at least a part of an inner wall of a pump chamber as a part of the liquid supplying flow path for changing the volume of the pump chamber; and a liquid remaining amount detecting unit that detects the remaining amount of the liquid of the liquid supplying source. The liquid supplying source is configured such that the volume of a liquid housing part as a closed space housing the liquid changes in accordance with the remaining amount of the liquid, and the liquid remaining amount detecting unit detects a liquid-end state in which the remaining amount of the liquid inside the liquid housing part is zero based on the amount of displacement of the displacement member for a case where the pump is driven for a suction operation in which the pump sucks the liquid into the pump chamber by displacing the displacement member in the direction in which the volume of the pump chamber increases.

According to the above-described liquid supplying device, in the suction drive operation in which the pump displaces the displacement member in the direction, in which the volume of the pump chamber increases, so as to suck the liquid from the upstream side that becomes the liquid supplying source side into the inside of the pump chamber, when the remaining amount of suppliable liquid inside the liquid housing part is zero, the displacement amount of the displacement member is different from the displacement amount for a case where the remaining amount of the liquid inside the liquid housing part is sufficient. Accordingly, the liquid remaining amount detecting unit can accurately detect the remaining amount of the liquid inside the liquid housing part to be in the “liquid end state” based on the difference of the displacement amount of the displacement member for a case where the pump is driven for the suction operation without following calculation having possibility of false detection. Accordingly, the liquid inside the liquid housing part can be supplied to the end without any waste in supplying the liquid from the upstream side that becomes the liquid supplying source side toward the downstream side.

According to a second aspect of the invention, there is provided a liquid supplying device including: a liquid supplying flow path through which a liquid is supplied from an upstream side as a liquid supplying source side toward a downstream side on which the liquid is consumed; a pump that is driven for a pumping operation in accordance with displacement of a displacement member constituting at least a part of an inner wall of a pump chamber as a part of the liquid supplying flow path for changing the volume of the pump chamber; and a liquid remaining amount detecting unit that detects the remaining amount of the liquid of the liquid supplying source. The liquid supplying source is configured such that the volume of a liquid housing part as a closed space housing the liquid changes in accordance with the remaining amount of the liquid, and the liquid remaining amount detecting unit detects the remaining amount of the liquid inside the liquid housing part based on the amount of displacement of the displacement member for a case where the pump is driven for a suction operation in which the pump sucks the liquid into the pump chamber by displacing the displacement member in the direction in which the volume of the pump chamber increases.

According to the above-described liquid supplying device, in the suction drive operation in which the pump displaces the displacement member in the direction, in which the volume of the pump chamber increases, so as to suck the liquid from the upstream side that becomes the liquid supplying source side into the inside of the pump chamber, the liquid housing part that is a closed space is deformed along the liquid surface of the liquid that decreases as the liquid is sucked, and accordingly, the liquid housing part is deformed so as to decrease the volume thereof. In the suction drive operation, the remaining amount (the remaining amount of the suppliable liquid that remains in a state that the liquid can be externally supplied) of the liquid inside the liquid housing part can be accurately detected based on a difference between the displacement amount of the displacement member for a case where the remaining amount of the liquid inside the liquid housing part is sufficient and the displacement amount of the displacement member for a case where the reaming amount is not sufficient, without following calculation having possibility of false detection. Accordingly, the liquid inside the liquid housing part can be supplied to the end without any waste in supplying the liquid from the upstream side that becomes the liquid supplying source side toward the downstream side.

In the above-described liquid supplying device, the liquid remaining amount detecting unit may be configured to detect the liquid-end state in which the remaining amount of the liquid inside the liquid housing part is zero or a liquid near-end state in which the remaining amount of the liquid is close to zero in a case where the amount of displacement of the displacement member for a case where the pump is driven for the suction operation is smaller than the amount of displacement, which is set in advance, for a case where the remaining amount of the liquid inside the liquid housing part is sufficient.

In other words, when all the remaining amount of suppliable liquid that remains inside the liquid housing part of the closed space of the liquid supplying source is sucked by the driving the pump for the suction operation, the liquid cannot be sucked from the inside of the liquid housing part further. Accordingly, the displacement amount of displacement member is smaller than the displacement amount for a case where the remaining amount of the liquid inside the liquid housing part is sufficient. Accordingly, under the above-described configuration, by detecting that the displacement amount of the displacement member for a case where the pump is driven for the suction operation is smaller than that for a case where the remaining amount of the liquid inside the liquid housing part is sufficient, the “liquid end state” or the “liquid near-end state” can be detected assuredly.

In the above-described liquid supplying device, the liquid remaining amount detecting unit may be configured to detect the liquid-end state in which the remaining amount of the liquid inside the liquid housing part is zero or a liquid near-end state in which the remaining amount of the liquid is close to zero in a case where the position of the displacement member at a time point after elapse of a predetermined time from start of the suction operation is different from the position of the displacement member, which is set in advance, for a case where the remaining amount of the liquid inside the liquid housing part is sufficient by detecting the position of the displacement member for a case where the pump is driven for the suction operation.

In other words, when the remaining amount of the suppliable liquid that remains inside the liquid housing part of the closed space of the liquid supplying source is zero, the liquid cannot be sucked from the inside of the liquid housing part of the liquid supplying source even in a case where the pump is driven for the suction operation. Thus, the displacement member is not displaced to the position for a case where the remaining amount of the liquid inside the liquid housing part, which is set in advance, is sufficient. Accordingly, under the above-described configuration, by detecting the position of the displacement member for a case where the pump is driven for the suction operation, the “liquid end state” or the “liquid near-end state” can be detected assuredly.

According to a third aspect of the invention, there is provided a liquid supplying device including: a liquid supplying flow path through which a liquid is supplied from an upstream side as a liquid supplying source side toward a downstream side on which the liquid is consumed; a pump that is driven for a pumping operation in accordance with displacement of a displacement member constituting at least a part of an inner wall of a pump chamber as a part of the liquid supplying flow path for changing the volume of the pump chamber; and a liquid remaining amount detecting unit that detects the remaining amount of the liquid of the liquid supplying source. The liquid supplying source is configured such that the volume of a liquid housing part as a closed space housing the liquid changes in accordance with the remaining amount of the liquid, and the liquid remaining amount detecting unit detects a liquid-end state in which the remaining amount of the liquid inside the liquid housing part is zero based on the drive load of the pump for a case where the pump is driven for a suction operation in which the pump sucks the liquid into the pump chamber by displacing the displacement member in the direction in which the volume of the pump chamber increases.

According to the above-described liquid supplying device, in the suction drive operation in which the pump displaces the displacement member in the direction, in which the volume of the pump chamber increases, so as to suck the liquid from the upstream side that becomes the liquid supplying source side into the inside of the pump chamber, when the remaining amount of suppliable liquid inside the liquid housing part is zero, the driving load of the pump is different from the driving load for a case where the remaining amount of the liquid inside the liquid housing part is sufficient. Accordingly, the liquid remaining amount detecting unit can accurately detect the remaining amount of the liquid inside the liquid housing part to be in the “liquid end state” based on the difference of the driving load of the pump for a case where the pump is driven for the suction operation without following calculation having possibility of false detection. Accordingly, the liquid inside the liquid housing part can be supplied to the end without any waste in supplying the liquid from the upstream side that becomes the liquid supplying source side toward the downstream side.

According to a fourth aspect of the invention, there is provided a liquid supplying device including: a liquid supplying flow path through which a liquid is supplied from an upstream side as a liquid supplying source side toward a downstream side on which the liquid is consumed; a pump that is driven for a pumping operation in accordance with displacement of a displacement member constituting at least a part of an inner wall of a pump chamber as a part of the liquid supplying flow path for changing the volume of the pump chamber; and a liquid remaining amount detecting unit that detects the remaining amount of the liquid of the liquid supplying source. The liquid supplying source is configured such that the volume of a liquid housing part as a closed space housing the liquid changes in accordance with the remaining amount of the liquid, and the liquid remaining amount detecting unit detects the remaining amount of the liquid inside the liquid housing part based on the drive load of the pump for a case where the pump is driven for a suction operation in which the pump sucks the liquid into the pump chamber by displacing the displacement member in the direction in which the volume of the pump chamber increases.

According to the above-described liquid supplying device, in the suction drive operation in which the pump displaces the displacement member in the direction, in which the volume of the pump chamber increases, so as to suck the liquid from the upstream side that becomes the liquid supplying source side into the inside of the pump chamber, the liquid housing part that is a closed space is deformed along the liquid surface of the liquid that decreases as the liquid is sucked, and accordingly, the liquid housing part is deformed so as to decrease the volume thereof. In the suction drive operation, the remaining amount (the remaining amount of the suppliable liquid that remains in a state that the liquid can be externally supplied) of the liquid inside the liquid housing part can be accurately detected based on a difference between the driving load of the pump for a case where the remaining amount of the liquid inside the liquid housing part is sufficient and the driving load of the pump for a case where the reaming amount is not sufficient, without following calculation having possibility of false detection. Accordingly, the liquid inside the liquid housing part can be supplied to the end without any waste in supplying the liquid from the upstream side that becomes the liquid supplying source side toward the downstream side.

In the above-described liquid supplying device, the liquid remaining amount detecting unit may be configured to detect the liquid-end state in which the remaining amount of the liquid inside the liquid housing part is zero or a liquid near-end state in which the remaining amount of the liquid is close to zero in a case where the drive load of the pump for a case where the pump is driven for the suction operation is larger than the drive load of the pump, which is set in advance, for a case where the remaining amount of the liquid inside the liquid housing part is sufficient.

In other words, when all the remaining amount of suppliable liquid that remains inside the liquid housing part of the closed space of the liquid supplying source is sucked by the driving the pump for the suction operation, the liquid cannot be sucked from the inside of the liquid housing part further. Accordingly, the driving load of the pump is larger than the driving load for a case where the remaining amount of the liquid inside the liquid housing part is sufficient. Accordingly, under the above-described configuration, by detecting that the driving load of the pump for a case where the pump is driven for the suction operation is larger than that for a case where the remaining amount of the liquid inside the liquid housing part is sufficient, the “liquid end state” or the “liquid near-end state” can be detected assuredly.

In addition, in the above-described liquid supplying device, the displacement member may be biased by a biasing member in the direction in which the volume of the pump chamber decreases.

In such a case, when the liquid is supplied by driving the pump for the pumping operation, the displacement member is displaced in resistance to the biasing force of the biasing member for either one of a case where the pump is driven for the suction operation and a case where the pump is driven for the ejection operation. In addition, for the other case, the displacement member is displaced to its original state by the biasing force of the biasing member, and accordingly, the driving load of the pump can decrease.

According to a fifth aspect of the invention, there is provided a liquid supplying device including: a liquid supplying flow path through which a liquid is supplied from an upstream side as a liquid supplying source side toward a downstream side on which the liquid is consumed; a pump that is disposed in a position located in the middle of the liquid supplying flow path and is driven for a pumping operation in accordance with rotation of a transmission member, which separates the liquid sucked from the upstream side and transmits the liquid to the downstream side, within the liquid supplying flow path; and a liquid remaining amount detecting unit that detects the remaining amount of the liquid of the liquid supplying source. The liquid supplying source is configured such that the volume of a liquid housing part as a closed space housing the liquid changes in accordance with the remaining amount of the liquid, and the liquid remaining amount detecting unit detects the remaining amount of the liquid inside the liquid housing part based on the drive load of the pump for a case where the pump is driven for a pumping operation.

According to the above-described liquid supplying device, in the pump drive operation in which the pump rotates the transmission member so as to suck the liquid from the upstream side that becomes the liquid supplying source side to the downstream side, the liquid housing part that is a closed space is deformed along the liquid surface of the liquid that decreases as the liquid is sucked, and accordingly, the liquid housing part is deformed so as to decrease the volume thereof. In the pump drive operation, the remaining amount (the remaining amount of the suppliable liquid that remains in a state that the liquid can be externally supplied) of the liquid inside the liquid housing part can be accurately detected based on a difference between the driving load of the pump for a case where the remaining amount of the liquid inside the liquid housing part is sufficient and the driving load of the pump for a case where the reaming amount is not sufficient, without following calculation having possibility of false detection. Accordingly, the liquid inside the liquid housing part can be supplied to the end without any waste in supplying the liquid from the upstream side that becomes the liquid supplying source side toward the downstream side.

In the above-described liquid supplying device, the liquid remaining amount detecting unit may be configured to detect the liquid-end state in which the remaining amount of the liquid inside the liquid housing part is zero or a liquid near-end state in which the remaining amount of the liquid is close to zero in a case where the drive load of the pump for a case where the pump is driven for a pumping operation is larger than the drive load of the pump, which is set in advance, for a case where the remaining amount of the liquid inside the liquid housing part is sufficient.

In other words, when all the remaining amount of suppliable liquid that remains inside the liquid housing part of the closed space of the liquid supplying source is sucked by the driving the pump for the suction operation, the liquid cannot be sucked from the inside of the liquid housing part further. Accordingly, the driving load of the pump is larger than the driving load for a case where the remaining amount of the liquid inside the liquid housing part is sufficient. Accordingly, under the above-described configuration, by detecting that the driving load of the pump for a case where the pump is driven for the suction operation is larger than that for a case where the remaining amount of the liquid inside the liquid housing part is sufficient, the “liquid end state” or the “liquid near-end state” can be detected assuredly.

In addition, in the above-described liquid supplying device, the liquid supplying source may be a liquid housing bag having flexibility and the inside of the liquid housing bag may be configured as the liquid housing part.

In such a case, the liquid housing part of the closed space for housing the liquid can acquire the liquid supplying source of which volume changes in accordance with the remaining amount of the liquid by using a simple configuration.

In addition, in the above-described liquid supplying device, drive of the pump may be stopped in a case where the liquid remaining amount detecting unit detects the liquid-end state.

In such a case, when the remaining amount of the liquid is in the “liquid end state” and the liquid cannot be sucked by continuing the driving of the pump for the suction operation, by stopping unnecessary driving of the pump, an excessive increase of the driving load of the pump can be suppressed.

According to a sixth aspect of the invention, there is provided a liquid ejecting apparatus including: a liquid ejecting head that ejects liquid; and the above-described liquid supplying device.

According to the above-described liquid ejecting apparatus, the same advantages as those of the above-described liquid supplying device can be acquired.

### BRIEF DESCRIPTION OF THE DRAWINGS

The invention will be described with reference to the accompanying drawings, wherein like numbers reference like elements.

FIG. 1 is a schematic diagram showing an ink jet printer according to an embodiment of the invention.

FIG. 2A is a schematic diagram showing a liquid supplying device according to an embodiment of the invention in a case where a pump is driven for a suction operation.

FIG. 2B is a schematic diagram showing a liquid supplying device according to an embodiment of the invention in a case where a pump is driven for an ejection operation.

FIG. 3A is a schematic diagram showing a liquid supplying device according to an embodiment of the invention at a time when ink is ejected.

FIG. 3B is a schematic diagram showing a liquid supplying device according to an embodiment of the invention at a time when ink is ejected and a pump is driven for a suction operation.

### DESCRIPTION OF EXEMPLARY EMBODIMENTS

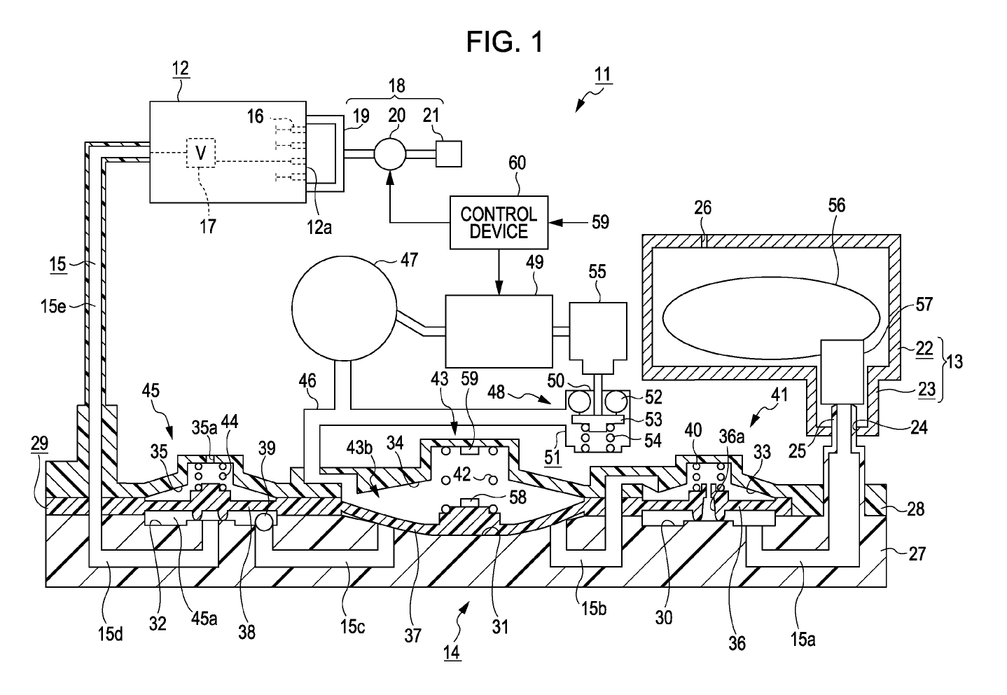

Hereinafter, an ink jet recording apparatus (hereinafter, referred to as a printer) according to an embodiment of the invention as one type of a liquid ejecting apparatus will be described with reference to FIGS. 1 to 3.

As shown in FIG. 1, a printer 11 according to this embodiment includes a record head 12 as a liquid ejecting head that ejects ink (liquid) onto a target (not shown) and an ink supplying unit 14 as a liquid supplying unit that supplies ink housed in the inside of an ink cartridge 13 to the record head 12. In the ink supplying unit 14, an ink flowing path (a liquid supplying flow path) 15 that supplies ink from the upstream side that is the ink cartridge 13 side toward the downstream side that is the record head 12 side in a state that the upstream end of the ink supplying unit is connected to the ink cartridge 13 and the downstream end of the ink supplying unit is connected to the record head 12 is provided.

In addition, in the printer 11, a plurality of the ink supplying units 14 is disposed in correspondence with the number of colors (types) of ink used in the printer 11. However, the configurations of the ink supplying units are the same. Thus, in FIG. 1, one ink supplying unit 14 that supplies ink of one color is shown together with the record head 12 and one ink cartridge 13. Hereinafter, a case where ink is supplied from the ink cartridge 13 disposed on the upstream side toward the record head 12 disposed on the downstream side through the ink flowing path 15 of one ink supplying unit 14 shown in FIG. 1 will be described as an example.

As shown in FIG. 1, in the record head 12, a plurality of (four in this embodiment) nozzles 16 corresponding to the number of the installed ink supplying units 14 is formed as openings on a nozzle forming face 12a that faces a platen (not shown). Ink is configured to be supplied from the ink flowing path 15 of a corresponding ink supplying unit 14 to each nozzle 16 through a valve unit 17. In other words, in the valve unit 17, a pressure chamber (not shown) that temporarily stores ink flowing from the ink flowing path 15 is disposed to be communicated with the nozzle 16. Inside the pressure chamber, when ink is ejected from the nozzle 16, an amount of ink corresponding to the amount of ink consumed by the ink ejection is configured to appropriately flow from the ink flowing path 15 in accordance with opening and closing operations of a flow path valve not shown in the figure.

In addition, in the printer 11, a maintenance unit 18 that performs a cleaning operation for the record head 12 so as to dissolve clogging or the like of the nozzle 16 of the record head 12 is disposed in a home position in which the record head 12 is located in a non-printing state. The maintenance unit 18 includes a cap 19 that can be brought into contact with the nozzle forming face 12a of the record head 12 so as to surround the nozzle 16, a suction pump 20 that is driven for sucking ink from the inside of the cap 19, and a waste liquid tank 21 to which the ink sucked from the inside of the cap 19 in accordance with driving of the suction pump 20 is discharged as waste ink. In the cleaning operation, the suction pump 20 is driven in a state that the cap 19 is moved from the state shown in FIG. 1 so as to be brought into contact with the nozzle forming face 12a of the record head 12, and accordingly, negative pressure is generated in an inner space of the cap 19. Accordingly, ink having increased viscosity or ink in which bubbles are mixed is sucked from the inside of the record head 12 and is discharged toward the waste liquid tank 21.

The ink cartridge 13 includes a case 22 formed of a synthetic resin material in an approximate box shape. From a lower wall of the case 22, a tube part 23 that is communicated with the inside of the case 22 is formed to protrude downward, and in the front end of the tube part 23, an ink supply opening 24 through which ink can be derived is formed. In addition, inside the case 22, an ink pack 56 as a liquid supplying source that is formed of a liquid housing bag having flexibility and has a closed space as a liquid housing part in which ink is enclosed (housed) is housed. In addition, in one end of the ink pack 56, an ink deriving member 57 used for deriving ink that is enclosed inside the ink pack to the outside is disposed. When the ink pack 56 is connected to the ink supplying unit 14, an ink supplying needle 25 that protrudes from the ink supplying unit 14 so as to form the upstream end of the ink flowing path 15 is inserted into the ink deriving member 57. Although not shown in the figure, inside the ink deriving member 57, a valve mechanism (not shown) having the function of a check valve is disposed. In addition, in the upper wall of the case 22, an air communication hole 26 that allows the inside of the case 22 to be communicated with the air is formed by perforation, and accordingly, an air pressure is applied to the outer face of the ink pack 56 in which ink is housed.

Next, the configuration of the ink supplying unit 14 will be described in detail.

As shown in FIG. 1, the ink supplying unit 14 includes a first flow path forming member 27 made of a resin material that becomes a base, a second flow path forming member 28 made of a resin material that is installed on the first flow path forming member 27 in a laminated state, and a flexible member 29 formed of a rubber plate or the like that is inserted between both the flow path forming members 27 and 28 for installation. Here, in a plurality of spots (three spots in this embodiment) located on the top face of the first flow path forming member 27, concave parts 30, 31, and 32 each forming a circular shape in the plan view are formed. In other words, one concave part 31 and two concave parts 30 and 32 that have a volume smaller than that of the concave part 31 and have an approximately same volume are formed to be horizontally arranged in parallel in the order of the concave part 30, the concave part 31, and the concave part 32 from the right side to the left side in FIG. 1.

On the other hand, in a plurality of spots (three spots in this embodiment) disposed on the bottom face of the second flow path forming member 28 that is laminated on the first flow path forming member 27, concave parts 33, 34, and 35 each having a circular shape in the plan view which face the concave parts 30, 31, and 32 formed on the top face of the first flow path forming member 27 vertically are formed. In other words, one concave part 34 and two concave parts 33 and 35 that have a volume smaller than that of the concave part 34 and have an approximately same volume are formed to be horizontally arranged in parallel in the order of the concave part 33, the concave part 34, and the concave part 35 from the right side to the left side in FIG. 1.

In other words, the ink supplying unit 14 allows employment of a laminated structure in which a plurality of plate-shaped constituent members are laminated by forming the concave parts 30 to 32 and the concave parts 33 and 35 on a same plane.

In addition, in the bottom part of the concave part 35 that is formed on the leftmost side of the second flow path forming member 28 in FIG. 1, an air communicating hole 35a that is communicated with the air is formed.

The flexible member 29 is inserted between the first flow path forming member 27 and the second flow path forming member 28 such that a plurality of spots (three in this embodiment) of the flexible member 29 are interposed between the concave parts 30 to 32 of the first flow path forming member 27 and the concave parts 33 to 35 of the second flow path forming member 28 so as to vertically partition the concave parts. As a result, a part of the flexible member 29 interposed between the concave part 30 of the first flow path forming member 27 and the concave part 33 of the second flow path forming member 28 is configured to serve as a suction-side valve body 36 that can be displaced by being elastically deformed between both the concave parts 30 and 33.

Similarly, a part of the flexible member 29 interposed between the concave part 31 of the first flow path forming member 27 and the concave part 34 of the second flow path forming member 28 is configured to serve as a diaphragm (a displacement member) 37 that can be displaced by being elastically deformed between both the concave parts 31 and 34. In addition, similarly, a part of the flexible member 29 interposed between the concave part 32 of the first flow path forming member 27 and the concave part 35 of the second flow path forming member 28 is configured to serve as a ejection-side valve body 38 that can be displaced by being elastically deformed between both the concave parts 32 and 35.

In terms of flexibly deformable areas of the suction-side valve body 36, the diaphragm 37, the ejection-side valve body 38, while the suction-side valve body 36 and the ejection-side valve body 38 have an almost same size, the diaphragm 37 has a size larger than that of the suction-side valve body 36 or the ejection-side valve body 38.

As shown in FIG. 1, in the first flow path forming member 27 and the second flow path forming member 28, a first flow path 15a that is communicated between the ink supplying needle 25 that protrudes from the top face of the second flow path forming member 28 and the concave part 30 of the first flow path forming member 27 is formed to configure a part of the ink flowing path 15 of the ink supplying unit 14. Similarly, in the first flow path forming member 27, the second flow path forming member 28, and the flexible member 29, a second flow path 15b that is communicated between the concave part 33 of the second flow path forming member 28 and the concave part 31 of the first flow path forming member 27 is formed to configure a part of the ink flowing path 15 of the ink supplying unit 14.

In addition, similarly, in the first flow path forming member 27, a third flow path 15c that is communicated between the concave parts 31 and 32 of the first flow path forming member 27 is formed to configure a part of the ink flowing path 15 of the ink supplying unit 14. In addition, in a flow path opening end of the third flow path 15c that is opened to the inner bottom face of the concave part 32 on the downstream side, a ball valve 39 that only allows passage of ink from the upstream side that is the concave part 31 side to the downstream side that is the concave part 32 side is disposed in a state that the ball valve is biased by a basing member not shown in the figure commonly in the valve closing direction in which the third flow path 15c is closed.

In addition, in the first flow path forming member 27, the second flow path forming member 28, and the flexible member 29, a fourth flow path 15d that is communicated between the concave part 32 of the first flow path forming member 27 and the top face of the second flow path forming member 28 is formed so as to configure a part of the ink flowing path 15 of the ink supplying unit 14. In addition, to a flow path opening end of the fourth flow path 15d that is opened to the top face of the second flow path forming member 28, one end (an upstream end) of an ink supplying tube 15e that configures a part of the ink flowing path 15 of the ink supplying unit 14 is connected. In addition, the other end (a downstream end) of the ink supplying tube 15e is connected to the valve unit 17 disposed on the record head 12 side.

In addition, as shown in FIG. 1, a part that becomes the suction-side valve body 36 of the flexible member 29 of the ink supplying unit 14 has a perforation hole 36a formed in the center thereof and is biased toward the inner bottom face of the concave part 30 disposed on the lower side by a biasing force of a coil spring 40 disposed inside the concave part 33 disposed on the upper side. In this embodiment, by the concave parts 30 and 33, the suction-side valve body 36, and the coil spring 40, a suction-side valve 41 that only allows passage of ink from the upstream side that becomes the ink cartridge 13 side toward the downstream side on which ink is consumed due to ink ejection of the record head 12 is configured.

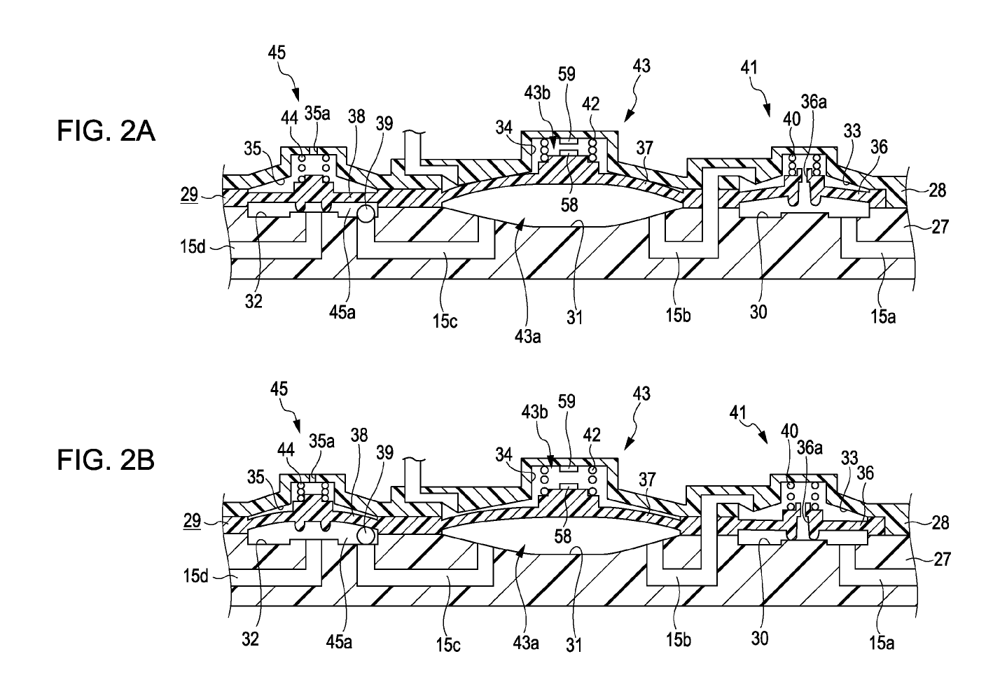

Similarly, a part that becomes the diaphragm 37 of the flexible member 29 of the ink supplying unit 14 is biased toward the inner bottom face of the concave part 31 disposed on the lower side by a biasing force of a coil spring (biasing member) 42 disposed inside the concave part 34 disposed on the upper side. In this embodiment, a pulse-type pump 43 is configured by the concave parts 31 and 34, the diaphragm 37, the coil spring 42, and a space region having a changeable volume that is formed by being surrounded by the diaphragm 37 the concave part 31 disposed on the lower side is configured to serve as a pump chamber 43a (see FIGS. 2A and 2B) of the pump 43. In other words, the diaphragm 37 configures a part of the inner face of the pump chamber 43a. In addition, to a top face of a part that becomes the diaphragm 37 of the flexible member 29, a sensor target 58 having a flat panel shape formed of a magnetic material is fixed. In the inner bottom face of the concave part 34 disposed on the upper side, a magnetic sensor 59 is disposed to face the sensor target 58. The amount of vertical displacement of the sensor target 58 is detected as the amount of vertical displacement of the diaphragm 37 by the magnetic sensor 59, and the result of detection is output to the control device 60 (see FIG. 1) of the printer 11.

The control device 60 is configured by a digital computer having a CPU (not shown) that performs various types of arithmetic computations for serving as a central processing unit, a ROM (not shown) and a RAM (not shown) that serve as memory units, and the like. When receiving a detection signal from the magnetic sensor 59, the control device 60 detects whether the remaining amount of ink (the remaining amount of liquid) inside the ink pack 56 is sufficient for performing a print operation. In other words, the control device 60 is configured to detect an “ink (liquid) end state” in which the remaining amount of ink (that is, the remaining amount of suppliable ink that remains in a state that the ink can be externally supplied inside the ink pack 56) is zero and an “ink (liquid) near-end state” in which the remaining amount of ink is close to zero.

The “ink end state” is a state in which the remaining amount of suppliable ink that remains inside the ink pack 56 is zero. The “ink end state”, for example, includes a state in which a small amount of ink that cannot be externally supplied from the inside of the ink pack 56 due to the influence of wrinkles generated at a time when the volume of the ink pack 56 having flexibility decreases, a capillary action generated between inner faces of the ink pack 56, or the like remains.

The control device 60 controls the driving state of the suction pump 20 in a cleaning operation for the record head 12, controls the driving state of the driving motor 49 in a pump 43 driving operation, and controls the overall operation state of the printer 11 as is needed. In this embodiment, a liquid remaining amount detecting unit is configured by the control device 60 and the magnetic sensor 59.

Similarly, a part that becomes the ejection-side valve body 38 of the flexible member 29 of the ink supplying unit 14 is biased toward the inner bottom face of the concave part 32 disposed on the lower side by a biasing force of a coil spring 44 disposed inside the concave part 35 disposed on the upper side. In this embodiment, the ejection-side valve 45 is configured by the concave parts 32 and 35, the ejection-side valve body 38, and the coil spring 44. Thus, a space region having a changeable volume that is formed by being surrounded by the ejection-side valve body 38 and the concave part 32 disposed on the lower side configures a part of the ink flowing path 15 and is configured to serve as an accumulative pressure chamber 45a that can store ink in a accumulatively pressed state.

The volume of the accumulative pressure chamber 45a is configured to be smaller than that of the pump chamber 43a, and the accumulative pressure chamber has almost the same size as that of the space region formed by being surrounded by the concave part 32 and the suction-side valve body 36. The biasing force of the coil spring 44 is operated in the direction for decreasing the volume of the accumulative pressure chamber 45a.

In addition, as shown in FIG. 1, to the concave part 34 of the second flow path forming member 28, a negative pressure generating device 47 formed of a suction pump or the like and an air opening mechanism 48 are connected through an air flowing path 46 divided in two branches. The negative pressure generating device 47 is driven so as to generate negative pressure by a driving force transferred through a one-way clutch not shown in the figure in a case where a driving motor 49 that can perform positive or negative rotation is driven for positive rotation. In addition, the negative pressure generating device is configured to be able to generate negative pressure inside the concave part 34 of the second flow path forming member 28 that is connected thereto through the air flow path 46. In this point, the space region having a changeable volume that is formed by being surrounded by the concave part 34 of the second flow path forming member 28 and the diaphragm 37 is configured to serve as a negative pressure chamber 43b that becomes in a negative-pressure state in accordance with driving of the negative pressure generating device 47.

In the air opening mechanism 48, an air opening valve 53 formed by additionally installing a sealing member 52 inside a box 51, in which an air opening hole 50 is formed, on the air opening hole 50 side is housed, and the air opening valve 53 is configured to be biased commonly by a biasing force of a coil spring 54 in the valve closing direction in which the air opening hole 50 is sealed. The air opening mechanism 48 is configured such that a cam mechanism 55, which is operated based on a driving force transferred through a one-way clutch not shown in the figure, is operated in a case where the driving motor 49 is driven for negative rotation, and the air opening valve 53 is displaced in the valve opening direction in resistance to the biasing force of the coil spring 54 by the operation of the cam mechanism 55. In other words, when the negative pressure chamber 43b that is connected to the air opening mechanism through the air flowing path 46 is in the negative pressure state, the air opening mechanism 48 is configured to dissolve the negative pressure by opening the inside of the negative pressure chamber 43b to the air by the valve opening operation of the air opening valve 53.

In FIG. 1, a configuration in which one negative pressure generating device 47, one air opening mechanism 48, and one driving motor 49 that drives those members are disposed for each of the plurality of the ink supplying units 14 corresponding to ink colors is exemplified. However, a configuration described below may be used. The connection end side of the air flowing path 46 that is connected to the negative pressure chamber 43b of the pump 43 of the ink supplying unit 14 may be branched in correspondence with the number of the plurality of installed ink supplying units 14 corresponding to the ink colors, and each connection end of the branched air flowing path 46 may be connected to the negative pressure chamber 43b of the pump 43 of the corresponding ink supplying unit 14. In such a case, by only disposing one negative pressure generating device 47, one air opening mechanism 48, and one driving motor 49 for the plurality of the ink supplying units 14, the ink supplying units 14 of the colors can be driven. Accordingly, miniaturization of the printer 11 can be implemented.

Next, the operation of the printer 11 configured as described above will be described below, with the operation of the ink supplying unit 14 particularly focused on.

First, as a premise, the state shown in FIG. 1 is right after replacement of the ink cartridge and is assumed to be a state that all the suction-side valve body 36 of the suction-side valve 41, the diaphragm 37 of the pump 43, and the ejection-side valve body 38 of the ejection-side valve 45 are pressed by the inner bottom faces of the concave parts 30, 31, and 32 disposed on the lower side in accordance with the biasing forces of the coil springs 40, 42, and 44. In addition, the ball valve 39 that can open or close the third flow path 15c of the ink flowing path 15 of the ink supplying unit 14 is in a state that the ball valve is biased to the valve closing position by a corresponding biasing member (not shown). In addition, the air opening mechanism 48 is in the valve closing state in which the air opening hole 50 is sealed by the air opening valve 53.

When the ink supplying unit 14 supplies ink from the ink cartridge 13 side to the record head 12 side in the above-described state shown in FIG. 1, first, the driving motor 49 is driven for positive rotation so as to drive the pump 43. Then, the negative pressure generating device 47 generates negative pressure, and accordingly, the negative pressure chamber 43b of the ink supplying unit 14 that is connected to the negative pressure generating device 47 through the air flowing path 46 is in a negative pressure state. Accordingly, the diaphragm 37 of the pump 43 is elastically deformed (displaced) to the negative pressure chamber 43b side in resistance to the biasing force of the coil spring 42, and thereby decreasing the volume of the negative pressure chamber 43b (see FIG. 2A). Then, to the contrary, the volume of the pump chamber 43a of the pump 43 that is partitioned from the negative pressure chamber 43b through the diaphragm 37 increases in accompaniment with the decrease in volume of the negative pressure chamber 43b.

In other words, the pump 43 displaces the diaphragm 37 in the direction in which the volume of the pump chamber 43a increases for suction driving. In particular, the diaphragm 37 is displaced from a position of the bottom dead center shown in FIG. 1 to a position of the top dead center shown in FIG. 2A. Accordingly, the inside of the pump chamber 43a is in the negative pressure state, and the negative pressure is applied to the concave part 33 of the suction-side valve 41 disposed on the upper side through the second flow path 15b. Thus, the suction-side valve body 36 is elastically deformed (displaced) in the upper direction (that is, the valve opening direction) in resistance to the biasing force of the coil spring 40 based on a pressure difference between the ink pressure of the inside of the concave part 30 disposed on the lower side and the pressure of the inside of the concave part 33 disposed on the upper side. As a result, the first flow path 15a and the second flow path 15b are communicated with each other through the perforation hole 36a of the suction-side valve body 36, and ink is sucked from the ink pack 56 disposed inside the ink cartridge 13 into the pump chamber 43a through the first flow path 15a, the concave part 30, the through hole 36a, the concave part 33, and the second flow path 15b. As the ink is sucked from the ink pack 56 into the pump chamber 43a as described above, the remaining amount of ink of the ink pack 56 gradually decreases, and the volume changes (that is, decreases) in correspondence with the decrease of the remaining amount of the ink.

When the pump 43 is driven for a suction operation, the negative pressure of the pump chamber 43a is applied to the downstream side of the ink flowing path 15 relative to the pump chamber 43a through the third flow path 15c, that is, the third flow path 15c. However, in the downstream end of the third flow path 15c, the ball valve 39 is biased in the valve closing direction, and the valve closing state is set not to be transferred to the valve opening state unless ink ejecting pressure of predetermined positive pressure (for example, pressure equal to or higher than 3 kpa) is applied to the ball valve 39 from the upstream side of the third flow path 15c by driving the pump 43 for an ejection operation. However, in such a case, negative pressure is applied to the ball valve 39, and accordingly, the valve closing state is maintained.

Then, next, in the state shown in FIG. 2A, the driving motor 49 is driven for negative rotation. Then, the air opening valve 53 performs a valve opening operation in resistance to the biasing force of the coil spring 54 by the operation of the cam mechanism 55 of the air opening mechanism 48 and opens the negative pressure chamber 43b that is in the negative pressure state to the air. Accordingly, the diaphragm 37 of the pump 43 is elastically deformed (displaced) to the lower side (that is, the inner bottom face side of the pump chamber 43a) in accordance with the biasing force of the coil spring 42 so as to increase the volume of the negative pressure chamber 43b (see FIG. 2B). Then, to the contrary, the volume of the pump chamber 43a of the pump 43 partitioned from the negative pressure chamber 43b through the diaphragm 37 decreases in accompaniment of the increase in the volume of the negative pressure chamber 43b.

In other words, the pump 43 displaces the diaphragm 37 is in the direction in which the volume of the pump chamber 43a decreases so as to be driven for an ejection operation. In particular, as shown in FIG. 2B, the diaphragm 37 is slightly displaced in the direction from the position of the top dead center to the position of the bottom dead center so as to apply pressure to the ink sucked into the pump chamber 43a at predetermined pressure (for example, pressure of about 30 kpa). Accordingly, ink is ejected from the inside of the pump chamber 43a. Thus, the ejection pressure is applied to the concave part 33 of the suction-side valve 41 disposed on the upper side through the second flow path 15b on the upstream side of the pump chamber 43a and elastically deforms (displaces) the suction-side valve body 36 downward (that is, in the valve closing direction) in cooperation with the biasing force of the coil spring 40. As a result, the first flow path 15a and the second flow path 15b are not communicated with each other by the valve closing operation of the suction-side valve body 36. Accordingly, suction of ink from the ink pack 56 of the ink cartridge 13 into the pump chamber 43a through the suction-side valve 41 is stopped, and a counter flow of the ink ejected from the pump chamber 43a in accordance with driving the pump 43 for the ejection operation to the ink pack 56 side of the ink cartridge 13 through the suction-side valve 41 is regulated.

When the pump 43 is driven for the ejection operation, the pressure (for example, the pressure of about 30 kpa) of the ink ejected from the pump chamber 43a is also applied to the downstream side of the ink flowing path 15 through the third flow path 15c. Accordingly, the ejection pressure of the pump 43 causes the ball valve 39 that is in the valve closing state to perform a valve opening operation, and thus the accumulative pressure chamber 45a that is formed by being surrounded by the ejection-side valve body 38 of the ejection-side valve 45 and the concave part 32 disposed on the lower side is communicated with the pump chamber 43a through the third flow path 15c. As a result, the ink from the inside of the pump chamber 43a is supplied to the inside of the accumulative pressure chamber 45a of the ejection-side valve 45 in a pressed state through the third flow path 15c.

Then, in the ejection-side valve 45, the ejection-side valve body 38 is elastically deformed (displaced) in the upper direction (that is, the valve opening direction) in resistance to the biasing force of the coil spring 44 by the pressure of the ink that is supplied in the pressed state to the inside of the accumulative pressure chamber 45a. As a result, as shown in FIG. 2B, the ink is temporarily stored in the pressed state inside the accumulative pressure chamber 45a. In relation thereto, the biasing force of the coil spring 44 of the ejection-side valve 45, for example, is set to about 13 kpa, so that the ejection-side valve body 38 can be elastically deformed upward by the pressure of the ink in a case where the ink flows into the inside the accumulative pressure chamber 45a with ejection pressure that can cause the ball valve 39 to perform a valve opening operation.

Thereafter, a state that the ejection pressure of the ink that is pressed by the diaphragm 37 and is ejected from the pump chamber 43a is balanced in the flow path regions (including the pump chamber 43a and the accumulative pressure chamber 45a) disposed on the downstream side of the ink flowing path 15 relative to the concave part 33 of the suction-side valve 41 disposed on the upper side is maintained. In other words, in the accumulative pressure chamber 45a, a state that the ejection-side valve body 38 is located in the position of the top dead center point is maintained, and a valve opening state in which the accumulative pressure chamber 45a and the fourth flow path 15d are communicated with each other is maintained.

Thereafter, when the ink is ejected from the record head 12 toward the target (not shown), ink of an amount corresponding to the amount of consumption of ink accompanied with the ink ejection is supplied from the inside of the ink flowing path 15 to the record head 12 side through the valve unit 17. Accordingly, in accordance with consumption of ink on the downstream side (the record head 12 side), ink of the corresponding amount is supplied from the inside of the pump chamber 43a to the downstream side that becomes the record head 12 side through the accumulative pressure chamber 45a in a pressed state based on the pressing force of the diaphragm 37 biased in the direction in which the volume of the pump chamber 43a decreases by the biasing force of the coil spring 42.

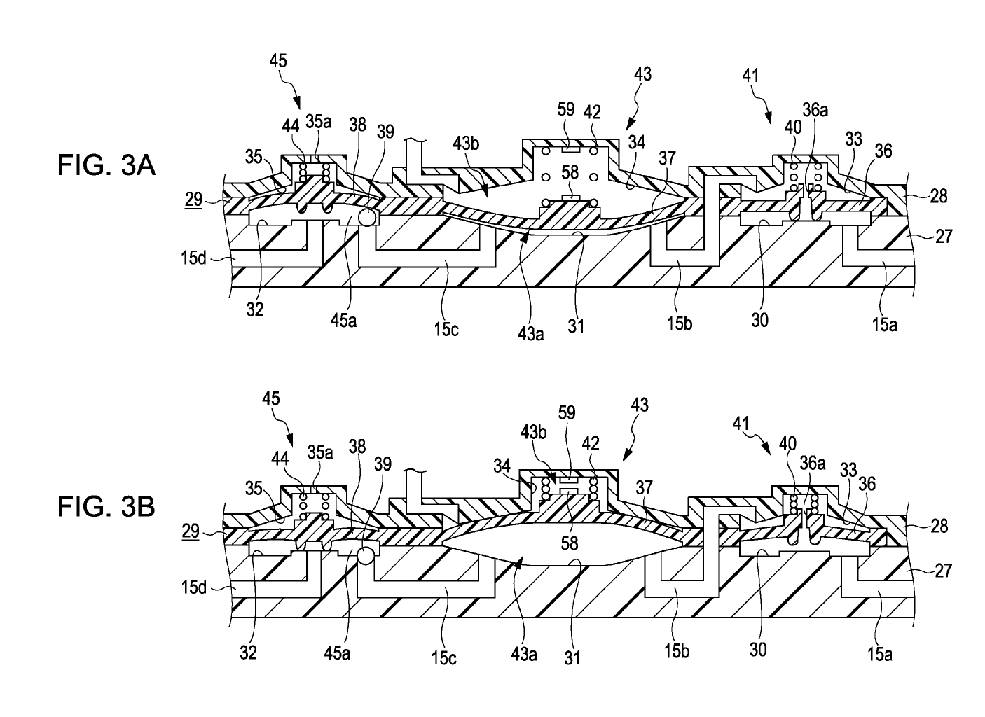

As a result, as shown in FIG. 3A, the volume of the pump chamber 43a gradually decreases, and finally, the diaphragm 37 is displaced near the position of the bottom dead center point. At this moment, inside the pump chamber 43a and the accumulative pressure chamber 45a, pressure of about 13 kpa is maintained in a balanced state. Accordingly, the ejection-side valve body 38 is located in the position of the top dead center point, and the volume of the accumulative pressure chamber 45a is maintained to be the maximum.

Then, the driving motor 49 is driven for positive rotation again, and the air opening valve 53 of the air opening mechanism 48 is displaced to the valve closing position in which the air opening hole 50 is closed. In addition, the negative pressure generating device 47 generates negative pressure, and the negative pressure chamber 43b is in a negative pressure state. Accordingly, the diaphragm 37 is elastically deformed (displaced) to the negative pressure chamber 43b side in resistance to the biasing force of the coil spring 42. In other words, the pump 43 starts to be driven for a suction operation again. As a result, as shown in FIG. 3B, the diaphragm 37 is displaced to the position of the top dead center point so as to increase the volume of the pump chamber 43a, and thus, the inside of the pump chamber 43a is in a negative pressure state. Accordingly, the suction-side valve body 36 is elastically deformed (displaced) in the valve opening direction by the operation of the negative pressure. Thus, the first flow path 15a and the second flow path 15b are communicated with each other through the through hole 36a of the suction-side valve body 36, and ink is sucked into the pump chamber 43a from the inside of the ink pack 56 of the ink cartridge 13, again.

On the other hand, in the accumulative pressure chamber 45a that is disposed on the downstream side of the pump chamber 43a, the pressure of the inside of the pump chamber 43a is lowered than that of the inside of the accumulative pressure chamber 45a, and accordingly, the ball valve 39 is displaced to the valve closing position. Accordingly, in the accumulative pressure chamber 45a, in accordance with pressing the ejection-side valve body 38 by using the coil spring 44, ink is continuously pressed to be supplied toward the record head 12 disposed on the downstream side through the fourth flow path 15d also during driving of the pump 43 for a suction operation. Thereafter, the pump 43 is driven for an ejection operation that is the same as described above, and the ink is pressed to be supplied to the record head 12 from the inside of the pump chamber 43a through the accumulative pressure chamber 45a that is disposed on the downstream side.

In the printer 11, in accordance with consumption of ink on the downstream side of the ink flowing path 15 such as the ink ejection from the record head 12, the ink pack 56 inside the ink cartridge 13 decreases its volume to be shrunk so as to respond to a decrease in the remaining amount of ink. When the remaining ink inside the ink pack 56 falls short of the remaining amount of ink needed for performing a print operation by ejecting ink form the record head 12, replacement of the ink cartridge 13 is needed for performing a print operation thereafter. Accordingly, in this embodiment, the remaining amount of ink inside the ink pack 56 is detected as follows.

In other words, when the suction-side valve body 36 of the suction-side valve 41 is in the open-valve state by driving the pump 43 for a suction operation in accordance with driving of the negative pressure generating device 47, the ink pack 56 is shrunk. Accordingly, ink of the amount corresponding to the decreased amount of the volume of the ink pack is sucked into the inside of the pump chamber 43a from the ink pack 56 side. In addition, since the diaphragm 37 is displaced toward the position of the top dead center point in accordance with driving of the pump 43 for a suction operation, the magnetic sensor 59 starts detecting a distance in the vertical direction to the sensor target 58 that is fixed to the top face of the diaphragm 37. Then, when the result of detection of the displacement amount is output to the control device 60, the control device 60 determines whether the value of the detected displacement amount after elapse of a predetermined time (that is, a time commonly needed for the diaphragm 37 to be displaced from the position of the bottom dead center point to the position of the top dead center point) reaches a threshold value for determination which is set and stored in advance as a value of the displacement amount corresponding to the position of the top dead center point. Then, the control device detects whether there is the remaining amount of suppliable ink inside the ink pack 56 based on the result of determination.

Here, when the remaining amount of ink inside the ink pack 56 is a sufficient remaining amount needed for performing ink ejection from the record head 12 in a print operation, the diaphragm 37 is displaced to the position of the top dead center point in accordance with the driving of the pump 43 for a suction operation. Accordingly, by determining that the value of the displacement amount detected based on a detection signal from the magnetic sensor 59 reaches the threshold value for determination, the control device 60 detects that sufficient suppliable ink remains inside the ink pack 56 and the remaining amount of suppliable ink is not in the “ink end state” or the “ink near-end state”.

On the other hand, when the remaining amount of suppliable ink inside the ink pack 56 is small to be in the “ink near-end state”, all the remaining small amount of ink that remains inside the ink pack 56 is sucked from the ink pack 56 side into the inside of the pump chamber 43a in accordance with driving of the pump 43 for the suction operation. As a result, the remaining amount of suppliable ink inside the ink pack 56 becomes zero, and the ink pack 56 is in a state that the ink pack cannot be shrunk so as to decrease its volume further. Then, since the amount of ink flowing into the inside of the pump chamber 43a from the ink pack 56 side is a small amount, the diaphragm 37 of the pump 43 cannot be displaced toward the position of the top dead center point further and stops the displacement between the position of the bottom dead center point and the position of the top dead center point.

Then, the magnetic sensor 59 outputs a detection signal corresponding to the amount of displacement of the diaphragm 37 that stops the displacement between the position of the bottom dead center point and the position of the top dead center point to the control device 60. Then, by determining that the value of the displacement amount detected based on the detection signal is smaller than the threshold value for determination, the remaining amount of suppliable ink in the ink pack 56 becomes zero, and the control device 60 detects that the remaining amount of suppliable ink is in the “ink near-end state” in which only the small amount of ink sucked into pump 43 can be supplied to the downstream side.

In addition, when the remaining amount of suppliable ink is in the “ink end state” at the time point of start of the driving of the pump 43 for a suction operation, ink that can be sucked does not remain inside the ink pack 56 even in a case where the pump 43 is driven for a suction operation. Accordingly, the diaphragm 37 of the pump 43 is not displaced from the initial position (for example, the position of the bottom center dead point) located at the start time point of driving for the suction operation to be stopped at the initial position. Then, the magnetic sensor 59 outputs a detection signal corresponding to the displacement amount (that is, the displacement amount of zero) of the diaphragm 37 that stops at the initial position to the control device 60. Then, by determining that the value of the displacement amount detected based on the detection signal is smaller than the threshold value for determination and is zero, the control device 60 detects the remaining amount of suppliable ink to be in the “ink end state” in which the remaining amount of suppliable ink inside the ink pack 56 is zero.

As described above, when detecting the “ink near-end state”, the control device 60 outputs a control signal used for notifying that replacement of the ink cartridge 13 housing the ink pack in the “ink near-end state” will be needed to be replaced soon so as to display a message indicating the notice on a panel.

In addition, when detecting the “ink end state”, the control device 60 outputs a control signal used for notifying that replacement of the ink cartridge 13 housing the ink pack 56 in the “ink end state” is needed to be replaced so as to display a message indicating the notice on the panel. In addition, since ink cannot be sucked from the inside of the ink pack 56 by driving the pump 43 for a suction operation, driving of the driving motor 49 for positive rotation is stopped so as to stop unnecessary driving of the pump 43 for a suction operation.

According to this embodiment, the following advantages can be acquired.

In the above-described embodiment, in the suction drive operation in which the pump 43 displaces the diaphragm 37 in the direction, in which the volume of the pump chamber 43a increases, so as to suck ink from the upstream side that becomes the ink cartridge 13 side into the inside of the pump chamber 43a, when the remaining amount of suppliable ink inside the ink pack 56 is zero, the displacement amount of the diaphragm 37 is different from the displacement amount for a case where the remaining amount of ink inside the ink pack 56 is sufficient. Accordingly, by detecting the difference of the displacement amount of the diaphragm 37 in the driving of the pump for the suction operation by using the magnetic sensor 59, the control device 60 can detect the remaining amount of ink inside the ink pack 56 precisely to be in the “ink end state” without following calculation having possibility of false detection. As a result, the ink inside the ink pack 56 can be supplied from the upstream side that becomes the ink cartridge 13 side toward the downstream side to the end without any waste.

In addition, when the displacement amount of the diaphragm 37 in driving the pump 43 for the suction operation is smaller than the displacement amount set in advance for a case where the remaining amount of ink inside the ink pack 56 is sufficient, the control device 60 determines the remaining amount of ink suppliable inside the ink pack 56 to be in the “ink end state” or the “ink near-end state”. In other words, when all the remaining amount of suppliable ink that remains inside the ink pack 56 of a closed space of the ink cartridge 13 in a state in which the ink can be supplied externally is sucked by the driving the pump 43 for the suction operation, ink cannot be sucked from the inside of the ink pack 56 further. Accordingly, the displacement amount of the diaphragm 37 is smaller than the displacement amount for a case where the remaining amount of suppliable ink inside the ink pack 56 is sufficient. Accordingly, by detecting that the displacement amount of the diaphragm 37 in driving the pump 43 for the suction operation is smaller than that for a case where the remaining amount of suppliable ink inside the ink pack 56 is sufficient by using the magnetic sensor 59, the control unit 60 can detected the “ink end state” or the “ink near-end state” of the inside of the ink pack 56 assuredly.

In addition, when the position of the diaphragm 37 at a time point after elapse of a predetermined time after start driving the pump 43 for the suction operation is different from the position for a case where the remaining amount of suppliable ink inside the ink pack 56 which is set in advance is sufficient, the control device 60 determines the remaining amount of suppliable ink inside the ink pack 56 to be the “ink end state” or the “ink near-end state”. In other words, when the remaining amount of suppliable ink inside the ink pack 56 of the closed space of the ink cartridge 13 is zero, ink cannot be sucked from the inside of the ink pack of the ink cartridge 13 by driving the pump 43 for the suction operation. Thus, the diaphragm 37 is not displaced to the position for a case where the remaining amount of suppliable ink inside the ink pack 56 which is set in advance is sufficient. Accordingly, by detecting that the position of the diaphragm 37 in driving the pump 43 for the suction operation by using the magnetic sensor 59, the control device 60 can detect the “ink end state” or the “ink near-end state” of the inside of the ink pack 56 assuredly.

In the above-described embodiment, the diaphragm 37 is biased by the coil spring 42 in the direction in which the volume of the pump chamber 43a decreases. Accordingly, when ink is supplied by driving the pump 43 for a pumping operation, the diaphragm 37 is displaced in resistance to the biasing force of the coil spring 42 for either one of a case where the pump 43 is driven for a suction operation or a case where the pump is driven for an ejection operation. In addition, for the other case, the diaphragm 37 is displaced to its original state by the biasing force of the coil spring 42, and accordingly, the load for driving the driving motor 49 can decrease.

In the above-described embodiment, the ink cartridge 13 houses the ink pack 56 having flexibility therein and houses ink on the inside (the liquid housing part of the closed space) of the ink pack 56. Accordingly, a liquid supplying source (the ink pack 56) in which the liquid housing part of the closed space housing the liquid (ink) changes in volume in accordance with the remaining amount of liquid (ink) can be acquired by using a simple configuration.

In the above-described embodiment, when the control device 60 detects the “ink end state” in which the remaining amount of suppliable ink inside the ink pack 56 is zero, the ink supplying unit 14 stops driving the driving motor 49. Accordingly, when the remaining amount of ink becomes the “ink end state” in which ink cannot be sucked by continuing driving the pump 43 for the suction operation, unnecessary driving of the driving motor 49 further is stopped, and thereby excessive driving load of the driving motor 49 can be suppressed.

In addition, the above-described embodiment may be changed as follows.

In the above-described embodiment, the control device 60 may be configured to detect the “ink end state” in which the remaining amount of suppliable ink inside the ink pack 56 is zero or the “ink near-end state” in which the remaining amount of suppliable ink is close to zero based on the drive load of the driving motor 49 in driving the pump 43 for the suction operation. In particular, the control device detects that the remaining amount of ink in the ink pack 56 is in the “ink end state” in a case where the drive load of the driving motor 49 in driving the pump 43 for the suction operation is larger than that in a case where the remaining amount of ink inside the ink pack 56 is sufficient which is set in advance.

In other words, when all the remaining ink remaining inside the ink pack 56 of the ink cartridge 13 as a closed space in a state that the ink can be externally supplied is sucked by driving the pump 43 for a suction operation, ink cannot be sucked further from the inside of the ink pack 56. Accordingly, the drive load of the driving motor 49 becomes larger than that for a case where the remaining amount of ink inside the ink pack 56 is sufficient. Thus, by detecting that the drive load of the driving motor 49 for a case where the pump 43 is driven for a suction operation is larger than that for a case where the remaining amount of ink inside the ink pack 56 is sufficient, the control device 60 can detect that the remaining amount of suppliable ink inside the ink pack 56 is in the “ink end state” assuredly.

When the pump is a rotary pump such as a gear pump as a volume pump, the amount of change of the drive load is large, and accordingly, the above-described detection method is particularly effective. In other words, a pump that can supply ink sucked from the ink pack 56 to the record head 12 side by rotating a transmission member disposed inside the ink flowing path 15 may be used. In such a case, the pump chamber is formed by closing the opened concave part and the opening of the concave part by using the downstream end of the second flow path and the upstream end of the third flow path, and the transmission member is connected to a motor inside the pump chamber so as to be rotatable. Then, ink is sucked by rotating the transmission member so as to decrease the pressure near the opening of the second flow path. The sucked ink is transported to the opening of the third flow path in a state that the ink is separated by the transmission member and the wall face of the ink flowing path and is transmitted to the third flow path.

As an example of the rotary pump, for a case of a gear pump, two gear wheels arranged so as to be engaged with each other in the pump chamber correspond to the transmission member. For a case of a roots pump, two rotors having an eyebrow shape correspond to the transmission member. In addition, for a vane pump, a rotor having a vane (partitioning wing) that is retractable in the diameter direction corresponds to the transmission member.

In the above-described embodiment, the sensor used for detecting the displacement amount of the diaphragm 37 is not limited to a non-contact type sensor such as the magnetic sensor 59. For example, as the sensor, a configuration in which a limit switch is disposed near the position of the top dead center point of the diaphragm 37 and a part of the diaphragm 37 is brought into tight contact with the limit switch for a case where the pump 43 is displaced to the position of the top dead center point may be used. In addition, as the non-contact type sensor, an optical sensor or the like may used.

In the above-described embodiment, the ink pack 56 as the liquid supplying source has such flexibility that the ink pack can be deformed by the suction force of the pump 43. In other words, the ink pack 56 is deformed along the liquid surface of ink housed therein. Accordingly, even for a case where a same amount of ink is sucked, as the amount of housed ink increases, the amount of deformation of the ink pack 56 decreases. Thus, by configuring the flexibility of the ink pack 56 such that the ink pack can be deformed by the suction force of the pump 43, as the amount of ink housed therein decreases, the amount of ink that can be sucked by driving the pump 43 for a suction operation for one time decreases. Accordingly, by detecting that the diaphragm 37 is not displaced to the position of the top dead center point, the “ink near-end state” in which the remaining amount of suppliable ink inside the ink pack 56 is decreased can be detected, and thereby a user can be notified of the need for replacement of the ink cartridge 13 in advance.

In the above-described embodiment, the liquid supplying source having a liquid housing part of a closed space therein is not limited to the ink pack 56 as the liquid housing bag having flexibility. For example, by forming an ink housing chamber inside the ink cartridge 13 as the liquid housing part and disposing a sealing member for sealing the ink on the liquid surface of the ink inside the ink housing chamber in a floating manner, the ink housing chamber may be configured as the liquid housing part having a changeable volume in a closed space. In such a case, the ink cartridge 13 becomes the liquid supplying source. For example, the liquid housing part of a closed space that has the volume changing in accordance with the remaining amount of liquid is included.

In the above-described embodiment, as a driving source of the pump 43, a device having both functions of a positive pressure generating device and the negative pressure generating device 47 may be used. In such a case, by performing the generation of positive pressure and generation of negative pressure alternately, the diaphragm 37 is displaced so as to perform pump driving without disposing a biasing member. Thereby, ink can be supplied.

In addition, instead of the negative pressure generating device 47 and the positive pressure generating device, a cam mechanism as a mechanism for displacing the diaphragm 37 may be used. In other words, for example, a base end part of a pulling member in which a locking part is formed is fixed to the diaphragm 37 pressed by the coil spring 42 of the compression spring. Then, by bringing the cam member into contact with the locking part of the pulling member, the diaphragm 37 may be displaced through the pulling member. In addition, when a tension spring is used, the base end part of the pressing member is fixed to the diaphragm 37, and the front end part may be configured to be pressed to the diaphragm 37 side by the cam member.

The “ink-end state” and the “ink near-end state” may be configured to be detected based on the displacement amount of the pulling member or the pressing member or the drive load of a motor that drives the cam member.

As the pump 43, a piston pump that directly presses the pump chamber 43a by using a piston that can reciprocate inside the negative pressure chamber 43b and changes the volume of the inside of the pump chamber 43a in accordance with the reciprocating movement may be used. In such a case, the “ink end state” and the “ink near-end state” can be detected based on the displacement amount of the piston and the drive load for displacing the piston. Similarly, the accumulative pressure chamber 45a may employ a piston structure.

In the above-described embodiment, as the suction-side valve 41, an electromagnetic valve may be used. In such a case, when driving of the pump 43 is stopped in accompaniment of the “ink end state” of the ink cartridge 13, the suction-side valve 41 is needed to be switched into a close-valve state.

In the above-described embodiment, the biasing member may be a biasing member having a different form such as a blade spring or rubber instead of the coil springs 40, 42, and 44. In such a case, the biasing forces applied to the suction-side valve 41, the ejection-side valve 45, and the ink inside the pump chamber 43a can be maintained regardless of the driving state of the negative pressure generating device 47.

In descriptions here, the liquid includes liquids (inorganic solvent, organic solvent, liquid solution, liquid resin, liquid metal (metal melt), and the like) other than ink, a liquid body formed by dispersing or mixing particles of a function material into liquid, and a fluid body such as gel. In addition, the liquid ejecting apparatus that ejects or discharges the above-described liquid, for example, may be a liquid body ejecting apparatus that ejects a liquid body including a material such as an electrode material or a coloring material (pixel material) used for producing a liquid crystal display, an EL (electroluminescence) display, a field emission display, or the like in a dispersed or dissolved form, a liquid ejecting apparatus that ejects a bioorganic material used for producing a bio chip, or a liquid ejecting apparatus that ejects a liquid that is used as a precision pipette and becomes a test material. In addition, the liquid ejecting apparatus may be a liquid ejecting apparatus that ejects a lubricant to a precision machine such as a clock or a camera in a pin-point manner, a liquid ejecting apparatus that ejects a transparent resin liquid such as an ultraviolet-curable resin onto a substrate for forming a tiny hemispherical lens (optical lens) used in an optical communication element or the like, a liquid ejecting apparatus that ejects an acid or alkali etching liquid for etching a substrate or the like, or a fluid ejecting device that ejects a fluid body such as gel (for example, physical gel).

In the above-described embodiment, although a liquid ejecting apparatus has been embodied as the ink jet printer 11, however, the liquid ejecting apparatus may be embodied as a liquid ejecting apparatus that ejects or discharges a liquid other than ink. In addition, the invention may be applied to various types of liquid ejecting apparatuses having a liquid ejecting head that ejects a small amount of liquid droplets or the like. Here, the liquid droplet represents the shape of the liquid ejected from the liquid ejecting apparatus and includes the shape of a particle, a tear, or a lengthy string. In addition, the liquid described here represents a material that the liquid ejecting apparatus can eject. For example, the liquid may be a material in the liquid phase and includes a liquid body having high or low viscosity, a material in the fluid phase such as sol, gel water, other inorganic solvent, organic solvent, liquid solution, liquid resin, or liquid metal (metal melt). In addition, the liquid includes not only liquid as one phase of a material but also a material in which particles of a function material formed of a solid material such as a pigment or a metal particle is dissolved, dispersed, or mixed as a solvent. As major examples of the liquid, there are ink and liquid crystal described in the embodiment above. Here, the ink includes general water-based ink, oil-based ink, and various types of liquid compositions such as gel ink or hot-melt ink. As detailed examples of the liquid ejecting apparatus, there are a liquid ejecting apparatus that ejects a liquid body including a material such as an electrode material or a coloring material used for producing a liquid crystal display, an EL (electroluminescence) display, an field emission display, or the like in a dispersed or dissolved form, a liquid ejecting apparatus that ejects a bioorganic material used for producing a bio chip, a liquid ejecting apparatus that ejects a liquid that is used as a precision pipette and becomes a test material, a coloring apparatus, and a micro dispenser. In addition, the liquid ejecting apparatus may be a liquid ejecting apparatus that ejects a lubricant to a precision machine such as a clock or a camera in a pin-point manner, a liquid ejecting apparatus that ejects a transparent resin liquid such as an ultraviolet-curable resin onto a substrate for forming a tiny hemispherical lens (optical lens) used in an optical communication element or the like, or a liquid ejecting apparatus that ejects an acid or alkali etching liquid for etching a substrate or the like. The invention may be applied to any one type of the above-described liquid ejecting apparatuses.

What is claimed is:

1. A liquid supplying device comprising:
a liquid supplying flow path through which a liquid is supplied from an upstream side as a liquid supplying source side toward a downstream side on which the liquid is consumed;
a pump that is driven for a pumping operation in accordance with displacement of a displacement member constituting at least a part of an inner wall of a pump chamber as a part of the liquid supplying flow path for changing the volume of the pump chamber; and
a liquid remaining amount detecting unit that detects the remaining amount of the liquid of the liquid supplying source,
wherein the liquid supplying source is configured such that the volume of a liquid housing part as a closed space housing the liquid changes in accordance with the remaining amount of the liquid, and
wherein the liquid remaining amount detecting unit detects the remaining amount of the liquid inside the liquid housing part based on the amount of displacement of the displacement member for a case where the pump is driven for a suction operation in which the pump sucks the liquid into the pump chamber by displacing the displacement member in the direction in which the volume of the pump chamber increases.

2. The liquid supplying device according to claim 1, wherein the liquid remaining amount detecting unit detects the liquid-end state in which the remaining amount of the liquid inside the liquid housing part is zero or a liquid near-end state in which the remaining amount of the liquid is close to zero in a case where the amount of displacement of the displacement member for a case where the pump is driven for the suction operation is smaller than the amount of displacement, which is set in advance, for a case where the remaining amount of the liquid inside the liquid housing part is sufficient.

3. The liquid supplying device according to claim 1, wherein the liquid remaining amount detecting unit detects the liquid-end state in which the remaining amount of the liquid inside the liquid housing part is zero or a liquid near-end state in which the remaining amount of the liquid is close to zero in a case where the position of the displacement member at a time point after elapse of a predetermined time from start of the suction operation is different from the position of the displacement member, which is set in advance, for a case where the remaining amount of the liquid inside the liquid housing part is sufficient by detecting the position of the displacement member for a case where the pump is driven for the suction operation.

4. A liquid supplying device comprising:
a liquid supplying flow path through which a liquid is supplied from an upstream side as a liquid supplying source side toward a downstream side on which the liquid is consumed;
a pump that is driven for a pumping operation in accordance with displacement of a displacement member constituting at least a part of an inner wall of a pump chamber as a part of the liquid supplying flow path for changing the volume of the pump chamber; and
a liquid remaining amount detecting unit that detects the remaining amount of the liquid of the liquid supplying source,
wherein the liquid supplying source is configured such that the volume of a liquid housing part as a closed space housing the liquid changes in accordance with the remaining amount of the liquid, and
wherein the liquid remaining amount detecting unit detects the remaining amount of the liquid inside the liquid housing part based on the drive load of the pump for a case where the pump is driven for a suction operation in which the pump sucks the liquid into the pump chamber by displacing the displacement member in the direction in which the volume of the pump chamber increases.

5. The liquid supplying device according to claim 4, wherein the liquid remaining amount detecting unit detects the liquid-end state in which the remaining amount of the liquid inside the liquid housing part is zero or a liquid near-end state in which the remaining amount of the liquid is close to zero in a case where the drive load of the pump for a case where the pump is driven for the suction operation is larger than the drive load of the pump, which is set in advance, for a case where the remaining amount of the liquid inside the liquid housing part is sufficient.

6. The liquid supplying device according to claim 1, wherein the displacement member is biased by a biasing member in the direction in which the volume of the pump chamber decreases.

7. A liquid supplying device comprising:
a liquid supplying flow path through which a liquid is supplied from an upstream side as a liquid supplying source side toward a downstream side on which the liquid is consumed;
a pump that is disposed in a position located in the middle of the liquid supplying flow path and is driven for a pumping operation in accordance with rotation of a transmission member, which separates the liquid sucked from the upstream side and transmits the liquid to the downstream side, within the liquid supplying flow path; and
a liquid remaining amount detecting unit that detects the remaining amount of the liquid of the liquid supplying source,
wherein the liquid supplying source is configured such that the volume of a liquid housing part as a closed space housing the liquid changes in accordance with the remaining amount of the liquid, and
wherein the liquid remaining amount detecting unit detects the remaining amount of the liquid inside the liquid housing part based on the drive load of the pump for a case where the pump is driven for a pumping operation.

8. The liquid supplying device according to claim 7, wherein the liquid remaining amount detecting unit detects the liquid-end state in which the remaining amount of the liquid inside the liquid housing part is zero or a liquid near-end state in which the remaining amount of the liquid is close to zero in a case where the drive load of the pump for a case where the pump is driven for a pumping operation is larger than the drive load of the pump, which is set in advance, for a case where the remaining amount of the liquid inside the liquid housing part is sufficient.

9. The liquid supplying device according to claim 1, wherein the liquid supplying source is a liquid housing bag having flexibility and the inside of the liquid housing bag is configured as the liquid housing part.

10. The liquid supplying device according to claim 1, wherein drive of the pump is stopped in a case where the liquid remaining amount detecting unit detects the liquid-end state.

11. A liquid ejecting apparatus comprising:
a liquid ejecting head that ejects liquid; and
the liquid supplying device according to claim 1.
